(19) United States
(12) Patent Application Publication
(10) Pub. No.: US 2025/0297686 A1
(43) Pub. Date: Sep. 25, 2025

(54) DRIVE FOR DRIVING A ROTARY VALVE

(71) Applicant: BONTAZ CENTRE, MARNAZ (FR)

(72) Inventors: Nicolas MAURE, Mieussy (FR); Maxence BERTHIER, Cluses (FR); Nathan MAREST, Lyon (FR)

(21) Appl. No.: 18/864,169

(22) PCT Filed: May 10, 2023
(86) PCT No.: PCT/EP2023/062455

§ 371 Date: Apr. 21, 2025

(30) Foreign Application Priority Data
May 10, 2022 (FR) 2204421

(51) Int. Cl. F16K 11/085; F16K 27/06; F16K 31/06

(52) U.S. Cl. CPC F16K 11/0853; F16K 27/065; F16K 31/0603

(57) ABSTRACT

Hydraulic rotary distributor including a case and a core, the case including a lateral wall, two end walls defining a hydraulic chamber, in which the core capable of rotating in the chamber about an axis of rotation is housed, an axial orifice, for example for supply, the lateral wall of the case including at least 2 lateral orifices, for example for outlet, which open into the hydraulic chamber, the core including a lateral surface facing the lateral wall, an axial opening, at least one lateral orifice, the core including a coupling to couple the end of a shaft of an actuator to the core, including a part provided with a groove for receiving the end of the shaft, the core including a housing capable of receiving the part, so that the latter transmits a rotation from the shaft to the core.

### TECHNICAL FIELD AND PRIOR ART

The present invention relates to a device for driving a rotary valve or a hydraulic distributor, for example used for cooling in the motor vehicle industry, the valve or the distributor preferably being electrically actuated. The invention also applies to the distribution of a coolant of a fuel cell.

In the motor vehicle field, the use of valves or of hydraulic distributors is routine for cooling certain parts of the engine, for example these are motorised valves with 1 or 2 inlet(s) and 2 outlets and a solenoid valve with 1 inlet and 2 outlets. These valves or distributors are generally controlled via an electric motor.

There are several types of hydraulic valves or distributors (the following description uses the term “distributor”, but it must be understood as also applying to a valve), in particular slide valves and rotary distributors.

Rotary distributors, also called ball and plug distributors, include a case defining a chamber in the shape of a cylinder of revolution provided with at least one fluid inlet intended to be connected to a source of liquid, and at least one fluid outlet intended to be connected to a pipe to bring the liquid towards the zone to be cooled. The inlet and the outlet open into the cylindrical wall of the chamber. The distributor also includes a rotating central part or core mounted in the chamber. The core includes an outer surface of revolution facing the cylindrical wall of the chamber. The core includes at least two orifices in its outer surface connected by a channel. The two orifices are oriented with respect to one another so that, when one of the orifices is facing the inlet, the other is facing the outlet. Thus, by turning the core in the chamber, it is possible to allow or interrupt the circulation between the inlet and the outlet and thus the circulation between the source of liquid and the zone to be cooled.

One problem is that of driving a rotary distributor device, for example of the type mentioned above: a simple drive system is sought that allows to easily transmit to the core a movement from an actuator.

The problem of automatically bringing the core back to an equilibrium or starting position when it has been brought to another position, for example to supply a duct, also arises. Moreover, such a distributor is in general supplied laterally, the lateral fluid inlet generating a torque that acts on all of the device. One problem is to create a distributor device allowing to solve this problem.

Another problem is to create a rotary distributor device allowing to distribute a fluid in a simultaneous and proportional manner between two distributor outlets. Indeed, a device is not known that can distribute a fluid between two outlets according to a predetermined distribution.

Another problem is that of the sealing between the core and the case; this is usually obtained by using joints, which poses the problem of monitoring the state of these joints and, also, of creating the device which must provide grooves in which these joints are positioned. This results in a device and a production method that are complex. It is sought precisely to create distributors with a simple, reliable design and including a reduced number of components.

### DISCLOSURE OF THE INVENTION

It is therefore one goal of the present invention to provide a reliable rotary hydraulic distributor with simplified manufacturing with respect to the hydraulic distributors of the prior art.

It is another goal of the present invention to provide a rotary hydraulic distributor allowing to solve at least one of the problems explained above.

The invention relates in particular to a hydraulic rotary distributor including a case and a rotating central part, or core, said case including a chamber in the shape of a cylinder of revolution receiving the core. The case also includes a lateral wall, two end walls defining a hydraulic chamber, in which the core capable of rotating in said chamber about an axis of rotation XX′ is housed, at least one axial orifice, for example a supply orifice, and at least one lateral orifice, for example 2 lateral orifices, that form for example one or 2 outlet orifice(s), which open(s) into the hydraulic chamber, the core including a lateral surface facing the lateral wall of the case, an axial face, for example for inlet or supply, at least one lateral orifice, for example a lateral outlet, and a duct, or a chamber, that connects said axial face and said lateral orifice, allowing a circulation, for example a supply, from or towards each of said lateral orifices of the case according to the angular position of the core in the case, the core including coupling means to couple the end of a shaft of an actuator to the core.

For example, the coupling means include a part provided with a groove for, or capable of, receiving the end of a shaft of an actuator, the core including a housing capable of receiving said part, so that the latter transmits a rotation from the shaft to the core.

Said part, as well as the housing, can each have a cylindrical shape, and be provided with a lug having a parallelepipedic shape, the housing including a space for receiving said lug.

Said groove and said lug can extend according to directions perpendicular or substantially perpendicular to each other. This allows to compensate for defects in coaxiality or in alignment according to the axes perpendicular to the axis of rotation.

Alternatively, said part as well as the housing can each have a parallelepipedic shape.

A hydraulic rotary distributor according to the invention can further include return means to bring the core back to an equilibrium or initial position after having been brought into a position distant from this equilibrium or initial position.

For example, these return means include a torsion spring, one end of which is fastened to the core and another end of which is fastened to a part of the distributor that remains stationary when the core is driven in rotation.

The invention thus also relates to a hydraulic rotary distributor including a case and a core, said case comprising a lateral wall, two end walls defining a hydraulic chamber, in which the core capable of rotating in said chamber about an axis of rotation XX′ is housed, at least one axial orifice, for example a supply orifice, and at least one lateral orifice, for example an outlet orifice, which open(s) into the hydraulic chamber, the core including a lateral surface facing the lateral wall of the case, an axial face, for example forming an inlet opening, at least one lateral orifice and a duct or a chamber that connects said axial face and said lateral orifice and that allows a circulation, for example a supply, from or towards each of said lateral orifices of the case according to the angular position of the core in the case, the distributor further including return means to bring the core back to an equilibrium or initial position after having been brought in rotation into a position distant from this equilibrium or initial position.

For example, said return means include a torsion spring, one end of which is fastened to the core and another end of which is fastened to a part of the distributor that remains stationary when the core is driven in rotation.

In a hydraulic rotary distributor according to the invention, the sealing between the lateral surface of the core and the lateral wall of the case can be ensured by the narrow passage or the small clearance, for example between 50 μm and 200 μm or even 300 μm (for example: 250 μm, in particular for a leak of 1% of 700 l/mn), between this lateral surface and this lateral wall.

Moreover, a hydraulic rotary distributor according to the invention can include means for limiting its angular movement in rotation when it is driven by an actuator. For example, the core includes a slot having a circular shape, which is stopped by a stop, in an initial position of the core, then in a maximal position of the latter.

According to one embodiment of a hydraulic rotary distributor according to the invention, one of the end walls includes a supply orifice that extends substantially perpendicularly to said axis of rotation XX′, or coaxially to the latter, the lateral wall of the case including at least 2 lateral orifices, for example 2 outlet orifices, which open into the hydraulic chamber, the core including a lateral surface facing the lateral wall of the case, an axial face, which is for example an inlet face, facing the axial orifice, which is for example a supply orifice.

Preferably, in a hydraulic rotary distributor according to the invention, the lateral orifice of the core has a shape allowing, in at least one other or in several intermediate angular position(s) between said 1^{st} angular position and said 2^{nd} angular position, a partial supply of the 2 lateral orifices of the case simultaneously.

For example, said lateral orifice of the core has an oblong or oval or ellipsoid shape, elongated according to an axis substantially perpendicular to the axis of rotation XX′. According to specific embodiments:
said lateral orifice of the core has an angular opening, measured in a plane perpendicular to the axis of rotation of the core, greater than the angle that separates, in the same plane, the 2 lateral orifices in the lateral wall of the case;
and/or the distance that separates the 2 points farthest from said lateral orifice of the core is greater than the distance that separates the 2 lateral orifices of the case;
and/or said inner duct of the core connects the axial face of the core and said lateral orifice of the core, this duct having a cross-section, perpendicularly to a direction of flow of fluid, that increases from said axial face towards said lateral orifice; for example the cross-section of the inner duct increases, preferably progressively, by a value between 1% and 3% for any increase, between on the one hand 5° or even 7° and on the other hand 12° or even 15°, in an angle measured between the axial face of the core and a plane perpendicular to the direction of flow or of circulation of fluid.

Advantageously, the case and/or the core is or are made of moulded plastic, which allows to reduce the mass of the distributor and the manufacturing time.

For example, the case and/or the core are made of plastic material.

According to an advantageous embodiment of a hydraulic rotary distributor according to the invention, the lateral orifices of the case are extended by ducts, which extend according to axes X₁₂, X₂₀ that have a point of intersection A located to the rear of the centre C of the core with respect to the lateral orifices of the case.

Regardless of the intended embodiment of a hydraulic rotary distributor according to the invention:
the axial face of the core can include an opening that faces the axial orifice of the case;
and/or the case can include 1, 2 or more lateral orifices.

The object of the present application is also a hydraulic rotary solenoid distributor including a distributor according to one or the other of the embodiments of the invention and an actuator, for example a motor or a gear motor, driving the core in rotation.

For example, the actuator includes an output shaft aligned according to the axis of rotation XX′.

The invention also relates to a method for distributing a fluid using a hydraulic rotary solenoid distributor according to the invention, the fluid being introduced by the axial orifice, which is thus a supply orifice, for example according to the direction of the axis of rotation XX′ or perpendicularly to the latter, and being guided by the inner duct of the core towards the lateral orifice of the latter then, according to the orientation of the core in the case, towards one and/or the other of the 2 lateral orifices of the case, which are thus outlet orifices.

According to one example, the fluid is a mixture of water and of glycol, for example of water at 60% and glycol at 40%. This fluid is suitable for example for the cooling of a fuel cell.

The invention also relates to a method for distributing a fluid using a hydraulic rotary solenoid distributor according to the invention, fluids being introduced by the 2 lateral orifices of the case, which are thus inlet or supply orifices, these fluids being guided by the inner duct of the core towards the axial orifice and being at least partly mixed in this inner duct. The 2 fluids can be of the same nature or be the same, but at different temperatures, wherein one can for example come from a heating member or element, for example a fuel cell, and the other from a cooling member or element, for example a radiator.

### BRIEF DESCRIPTION OF THE DRAWINGS

The present invention will be better understood on the basis of the following description and the appended drawings wherein:

FIG. 1 is an exploded view of an example of a hydraulic rotary distributor to which the invention can be applied, this distributor including one inlet and two outlets.

FIG. 2A is a perspective view of the rotary central part of the distributor of FIG. 1.

FIG. 2B is a front view of the rotary central part of the distributor of FIG. 1.

FIG. 3 is a side view of the duct of the rotary central part of the distributor of FIG. 1.

FIG. 4 is a top view of the case and of the core of the distributor of FIG. 1, allowing a partial flow towards each of the 2 outlet paths.

FIG. 5A is a top view of the case and of the core of an example of a distributor in a 1^{st} switching state, allowing a flow only towards one of the 2 distributor outlet paths.

FIG. 5B is a top view of the case and of the core of the same example of a distributor in a 2^{nd} switching state, allowing a flow only towards the other of the 2 distributor outlet paths.

FIG. 6 is a view of an aspect of the invention, including a compartment of a lower part of the core to receive means for coupling with a shaft of an actuator.

FIG. 7A is a view of an exemplary embodiment of the coupling means allowing to couple the core to a shaft of an actuator.

FIG. 7B is a view of another exemplary embodiment of the coupling means allowing to couple the core to a shaft of an actuator.

FIG. 8 is a view illustrating an embodiment of return means allowing to bring the core back into an initial position.

FIG. 9A is a view of a distributor to which the invention can be applied, with axial supply.

FIG. 9B is a view of a distributor to which the invention can be applied, with axial outlet of the fluid.

FIG. 10A

FIG. 10B

FIG. 10C show steps of creating a core of a rotary hydraulic distributor to which the invention can be applied.

FIG. 11A-FIG. 11C show another aspect of a core of a rotary hydraulic distributor according to the invention.

### DETAILED DISCLOSURE OF SPECIFIC EMBODIMENTS

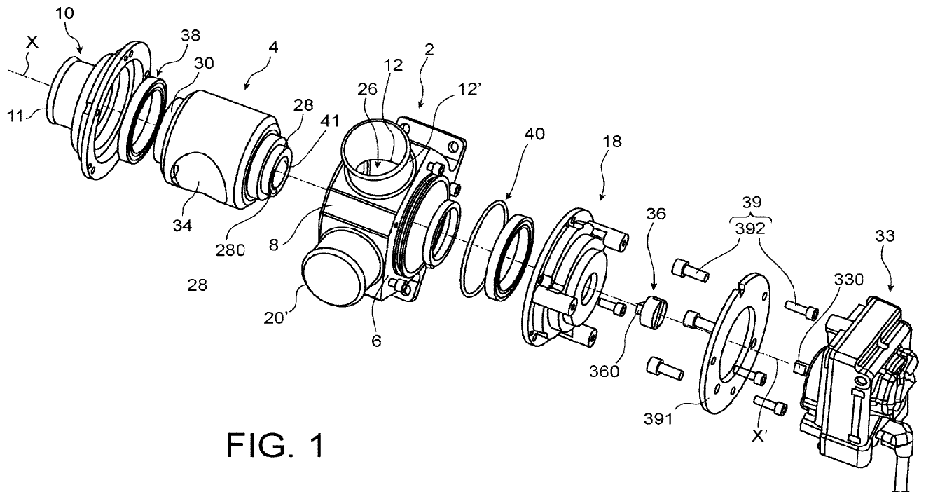

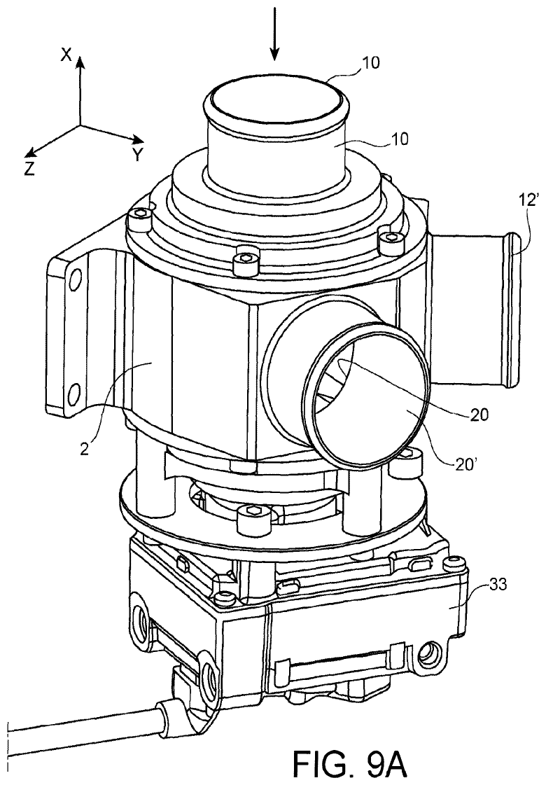

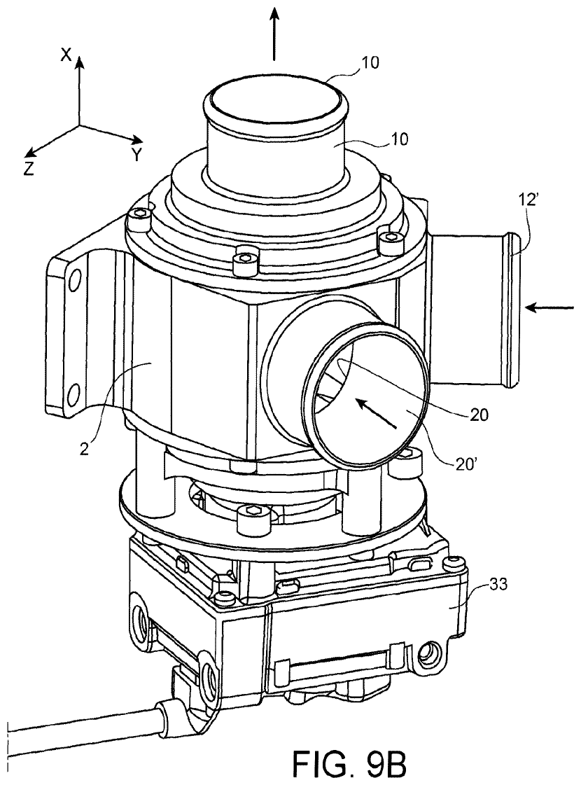

FIG. 1 shows an exemplary embodiment of a rotary hydraulic distributor to which the invention can be applied, of the type including one inlet and two outlets. It is understood that the distributor can include one or more outlets. Moreover, the inlet or the inlets can be inverted with the outlet(s), as explained below (in relation to FIG. 9B).

The distributor D includes a case 2 or valve body, having substantially the shape of a cylinder of revolution about the axis XX′, and a central part 4, called core, mounted in the case 2 and capable of rotating in the latter.

In the example shown, the case 2 includes a bottom 6 and a substantially cylindrical one-piece lateral wall 8, and an inlet cover 10 which includes an opening 11 by which the fluid enters the device; the fluid thus flows according to a direction aligned with the axis XX′, then is distributed, by the core 4, towards one or more lateral outlets of the case, preferably oriented in a plane YZ perpendicular to the axis XX′ (see for example FIG. 9A). The inlet cover 10 is for example assembled or rigidly connected to the case 2 in a removable manner, for example by screws, or in a fixed manner, for example by welding, also for example by ultrasound welding (in particular if the parts are made of plastic material).

It should be noted that the coaxial arrival of the fluid allows to reduce the torque produced by the latter on the entire distributor. This is advantageous regardless of the flow rate of the fluid, but especially for high flow rates, for example between 200 and 700 litres per minute. The case 2 includes a first outlet orifice 20 formed in the lateral wall 8, which can be extended by a 1^{st} duct 20′ intended for example to bring the liquid towards a given zone, for example a zone to be cooled, and a second outlet orifice 12, which can be extended by a 2^{nd} duct 12′ also intended for example to bring the liquid towards a given zone, for example also a zone to be cooled. These ducts 12′, 20′ are for example welded onto the base of the orifices 12 and 20, respectively. The case 2 defines a hydraulic chamber 26. The outlet orifices 12 and 20 are distributed angularly on the lateral wall around the axis XX′.

The case 2 also includes a motor cowl 18, which can be for example assembled or rigidly connected to the case 2 in a removable manner, for example by screws, or in a fixed manner, for example by welding, also for example by ultrasound welding (in particular if the parts are made of plastic material). All of the device is actuated by an actuator 33 (for example a motor or a gear motor). Coupling means, or a member, 36 connect a shaft of the actuator to the core 4 in order to drive the latter in rotation about the axis XX′. Adaptation means 39, including for example a crown 391 and fastening means 392, for example screws, can be provided to assemble the actuator 33 with the cowl 18. The axis of the actuator passes through the central orifice of the crown.

The device of FIG. 1 is shown assembled in FIG. 9A.

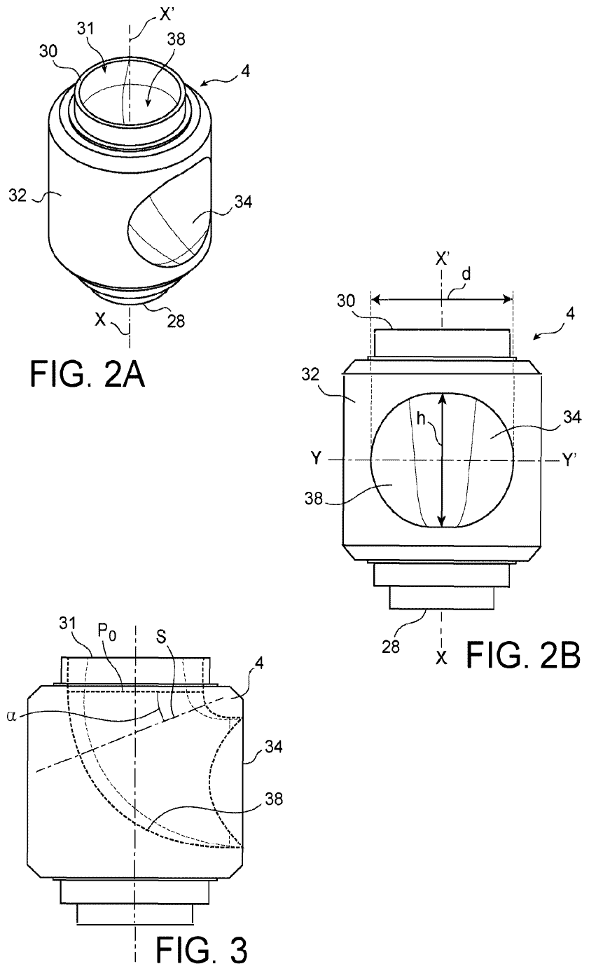

FIGS. 2A and 2B show the core 4 also having the shape of a cylinder of revolution with axis XX′. This core 4 is mounted in the hydraulic chamber, in which it is capable of rotating about the axis XX′. It includes two end faces 28, 30 and a lateral surface 32.

When this core 4 is mounted in the hydraulic chamber, its end face 28 is facing the bottom of the case 2 (located on the actuator side) and its end face 30 is facing the cover 10. The end face 30 includes an opening 31 intended to be aligned with the opening 11 of the cover 10 in order to receive the flow of fluid that flows, along the axis XX′ in this example. The lateral surface 32 of the core 4 includes a lateral opening 34, which allows to guide the fluid towards one or more of the outlet orifices 12, 20. A ball bearing 37 can be provided, to ensure the guiding in rotation of the core 4 in the case 2; moreover, a static joint can advantageously be provided between the case 2 and the cover 10 to avoid leaks of liquid. Likewise, one or more joint(s) 40 is/are advantageously provided between the end face 6 and the cowl 18 to avoid leaks of liquid. The reference 37′ also designates a ball bearing.

A duct 38 connects the opening 31 for inlet of the fluid into the core 4 and the opening 34 for outlet of the fluid from the core. The shape of this duct is shown in more detail in FIG. 3. Preferably, this duct widens, from the inlet opening 31, which is for example circular, towards the outlet opening 34, which preferably has an elongated shape as explained below.

A plane P, substantially orthogonal to the direction of flow of the fluid, is shown in FIG. 3: according to one exemplary embodiment, this plane P makes an angle α with a plane P₀, parallel to the plane in which the inlet opening 31 is located. The intersection of this plane P with the duct 38 has a surface area S, which increases, for example in a linear manner, as the angle α increases. This progressive increase allows a reduction in the head losses.

Table I below indicates, for various values of the angle α, various values of the surface area S which, as already indicated above, can increase as the angle α increases.

TABLE 1

| | | Deviation | Deviation |
|---|---|---|---|
| | Section | from the | from the |
| Position | (mm²) | previous | initial |
| 0° | 2017.91 | | |
| 10° | 2045.51 | 1% | 1% |
| 20° | 2081.97 | 2% | 3% |
| 30° | 2125.2 | 2% | 5% |
| 40° | 2173 | 2% | 8% |
| 50° | 2223.02 | 2% | 10% |
| 60° | 2273.66 | 2% | 13% |
| 70° | 2319.19 | 2% | 15% |
| 80° | 2359.7 | 2% | 17% |
| 90° | 2391.16 | 1% | 18% |
| Final | 2412.57 | 1% | 20% |

In its final part, while the angle α is equal to 90°, the surface area S can further increase as understood from the above table (see the difference between the value of S for 90° and the “final” value).

For example, for each increase of the angle α by 10°, or more generally between 7° (or even) 5° and 12° (or even) 15°, the surface area S can increase by a relative value between 1 and 3%, for example 2%.

Preferably, the outlet orifice 34 has, in projection in a plane parallel to the axis XX′ and perpendicular to the direction of outlet of the fluid, an elongated or oblong shape along an axis YY′ substantially perpendicular to the axis XX′. For example, this projection of the outlet orifice has an ellipsoid shape, the longer axis of the ellipsoid being the same as the axis YY′.

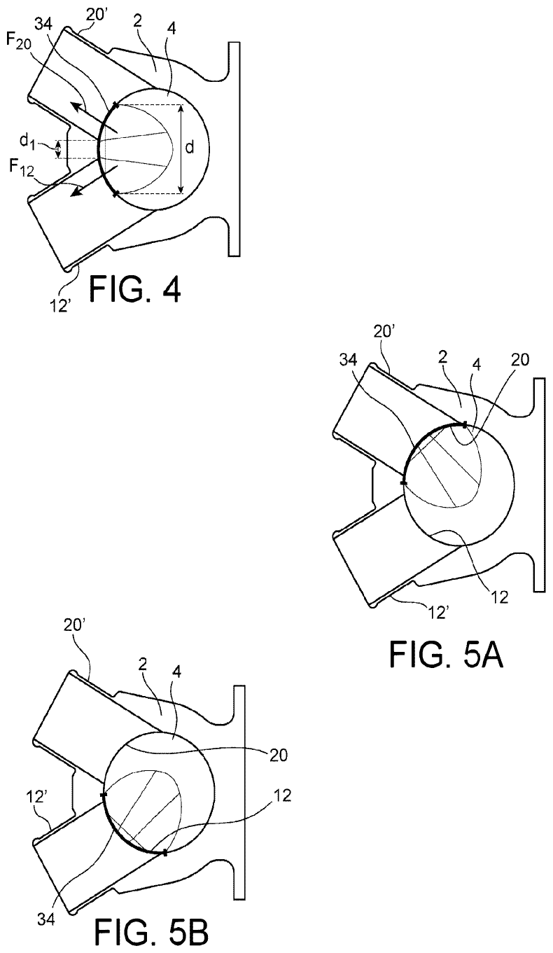

The distance d (FIG. 2B) between the points farthest from this opening along the axis YY′ is preferably greater than the distance d₁ that separates 2 neighbouring outlet openings 12, 20 of the rotary case 2, as illustrated in FIG. 4, which shows, schematically, the case 2, with its 2 outlets 12, 20 and the core 4 with its outlet orifice 34. In FIG. 4, the latter opens partly onto the outlet 12 and partly onto the outlet 20, thus allowing a 1^{st} flow F12 to flow via the outlet 12 and a 2^{nd} flow F20 to flow via the outlet 20. The ratio of these flows can be modified by modifying, using the actuator 33, the orientation of the core 4 in the case 2.

The ratio of these flows can be modified by modifying, using the actuator 33, the orientation of the core 4 in the case 2: for several positions of the core, the orifice 34 opens partly onto the outlet 12 and partly onto the outlet 20 and, for each of these positions, the ratio of these flows is different from what it is in other positions.

In certain positions, the outlet orifice 34 can open only into one or the other of the outlets 12, 20. That is what is shown in FIG. 5A (outlet of the flow entirely towards the outlet 20) and 5b (outlet of the flow entirely towards the outlet 12).

Preferably, the clearance between the core 4 and the inner surface of the case 2 allows to ensure the sealing between 2 neighbouring outlet paths 12, 20, without implementing a joint. This allows to avoid:
an additional friction (between the joint and the inner surface of the case 2 or between the joint and the outer surface of the core 4);
a monitoring of the state of the joint and a step of replacement when the latter is worn.

For this purpose, it is possible to calculate the maximum clearance h that can be implemented between the outer surface of the core and the inner surface of the case 2. The slot can be modelled by a system consisting of 2 plates, disposed between the 2 outlets and separated by a width b over a length l, the slot having a thickness h; one of the outlets is at a pressure p1 (upstream pressure) while the other is at a pressure p2 (downstream pressure, p1>p2). Since the fluid has a dynamic viscosity η, the following formula is applied, which gives the flow rate dV/dt of the leak:

$$dV / dt = ( {h}^{3} b / 12 η l ) \cdot ( p 1 - p 2 ) \qquad [ Math 1 ]$$

### For:

a fluid consisting of a mixture of water (at 60%) and glycol (at 40%);
having a viscosity, at 100° C., of 2×10⁻³ Pa·s,
a difference in pressure (p1−p2) of 1 bar,
values of b=4.5×10⁻² m and L=1.77×10⁻² m.

A maximum radial clearance of 1.85×10⁻⁴ m is obtained in order to have a leak flow rate of at most 4 l per minute.

According to the desired maximum leakage rate, the viscosity of the fluid (which itself can depend on the temperature), the geometry parameters, the difference in pressure, the above formula can be adapted. The part dimensions 2, 4 actually obtained during the manufacturing can then be compared to the maximum clearance obtained according to the above modelling, in order to verify whether the parts will meet the desired sealing requirement.

In general, it is possible to use the temperature of use which leads to the lowest viscosity, since the flow rate of the leak is inversely proportional to the viscosity. This temperature is most often the maximum temperature of use. For example, for a use for a coolant used between −40° C. and +100° C., the latter value of 100° C. is used.

More generally, the clearance will be for example between 50 μm and 200 μm or even 300 μm (for example: 250 μm, in particular for a leak of 1% of 700 l/mn).

This sealing without a joint can be applied not only to the distributors described above in relation to FIGS. 1-3 but also to any distributor implementing a rotary element in a distribution body, in particular to any distributor:
including an injection of the fluid, not in an axial manner (according to the axis XX′) as described above, but in a manner lateral to the body 2;
and/or for which the core includes a distribution channel having a uniform cross-section and the end of which, located facing the outlet orifice(s), can have an elongated shape as described above or have a circular shape which corresponds, or is identical, to the cross-sections of the openings 12, 20.

Consequently, the sealing can be ensured by the narrow passage or the small clearance between this lateral surface and this lateral wall.

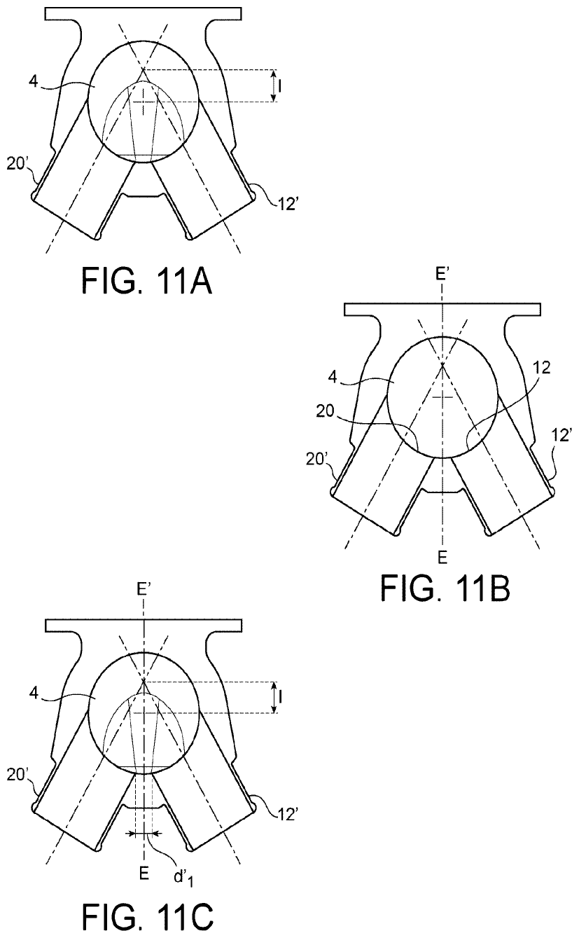

Another aspect of the invention will be explained in relation to FIGS. 11A-11C. The lateral ducts 12, 20 extend according to axes respectively X₁₂, X₂₀, which are coplanar (in a plane perpendicular to the axis XX′) and intersect at a point A. This point can be identical to the centre C of the core 4 (which is also the centre of the bore of the body 2 into which the core is inserted). But, according to an embodiment of interest of the present invention, the point A is moved and located to the rear of the point C, at a distance I from the latter. The point C is thus closer to the orifices 12, 20 than the point A; the 2 points A and C are located on an axis EE′ that is a central axis of the core (and of the bore of the body 2) in a plane perpendicular to the axis XX′ (or median plane of the body 2). A is thus farther from the orifices 12, 20 than the point C. This allows, for constant diameters of ducts 12′, 20′, to increase the distance, called overlap length, that separates these ducts (this is the length d₁ that is also shown in FIG. 4). As this distance increases, the flow rate of the leak, as calculated according to the formula given above, decreases. The example of FIG. 11B is that of a device in which the point of intersection A and the centre C are the same. The inner diameter of the duct 38 is, in the plane of the axes X₁₂, X₂₀, equal to 80 mm. The length d₁ is 1.36 mm. In FIG. 11C, the point A has been offset by a distance I of 20.8 mm to the rear of the point C: the length d₁ becomes equal to d′₁=11.33 mm, or more than 8 times greater than the initial length; thus, the leak is itself reduced by a factor>8. The gain obtained by the relative offset of the points A and C can thus be very substantial.

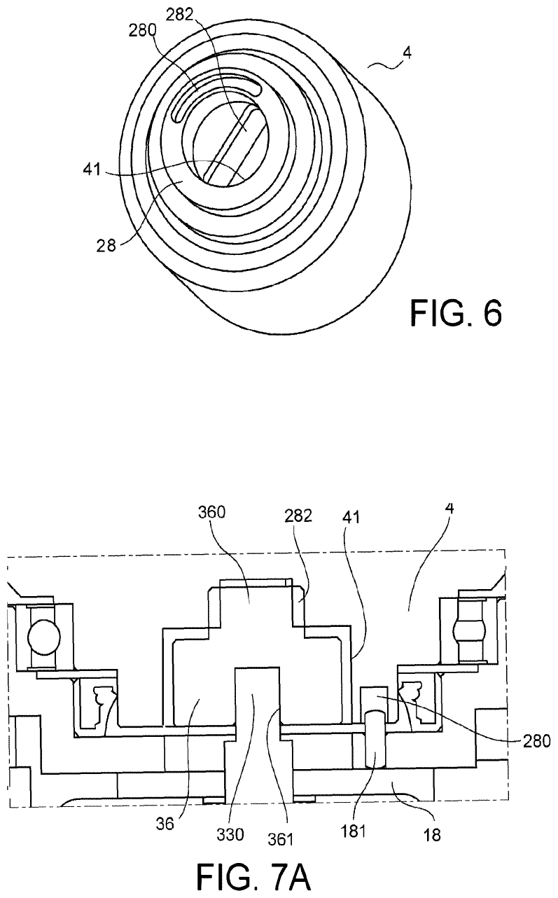

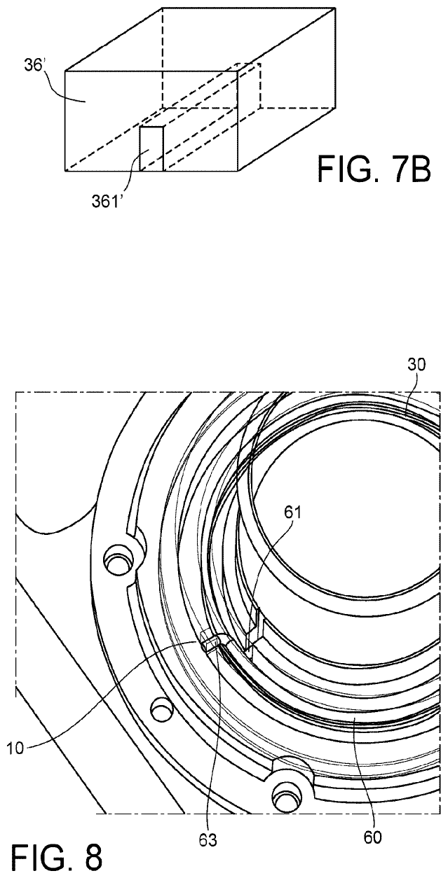

According to the present invention, the coupling or drive means or part 36 of a device as described above can have the shape shown in FIGS. 1 and 6, 7: these means are for example in the shape of a cylinder (FIG. 7A), in the lower part of which a groove 361, preferably having a parallelepipedic shape, which allows to receive the end of the shaft 330 of the actuator 33 (see FIG. 1) can be made. The coupling part 36 is itself housed in a lower compartment 41 of the core 4 (see FIGS. 6 and 7) and includes, in its upper part, a lug 360, for example having a parallelepipedic shape, which allows to actuate the core 4 in rotation when the shaft 330 actuates the part 36 also in rotation. Preferably, the groove 361 and the lug 360 each extend according to a direction perpendicular to the axis XX′ (each has a width smaller than its length, which is substantially the diameter of the cylinder 36), but they both extend according to 2 directions perpendicular to each other (in other words: the groove 361 extends according to a direction perpendicular to that of the lug), which allows to make up for the defects in coaxiality according to the 2 axes perpendicular to the axis of rotation XX′.

The lower compartment 41 of the core 4 has a shape complementary to that of the part 36: in particular, it includes 1 slot 282 into which the lug 360 is inserted.

Alternatively (see FIG. 7B), the coupling means 36′ can have a parallelepipedic shape in the lower part includes a groove 361′ which allows to receive the end of the shaft 330 of the actuator 33. This part 36′ is itself housed in the lower compartment 41 of the core 4 (see FIGS. 6 and 7) which has a parallelepipedic shape, so that, when the actuator 33 drives the part 36′ in rotation, the latter drives, in turn, the core 4 in rotation. Advantageously, the lower face 28 of the core 4 has a circular groove 280 (see FIGS. 1, 5 and 6) that allows to house a pin 181 connected to the motor cowl 18: this pin forms a stop for the movement of the core 4 when the latter is rotated by the actuator 33. The stop stops or limits the travel of the slot, in an initial position of the core, then in a maximal position of the latter; the initial position can for example correspond to a flow of 0 in the outlet 20, the final position can correspond to a flow of 0 in the outlet 12 (see FIGS. 5A and 5B).

According to another aspect of the invention, a torsion spring can be connected, by one of its ends, to the core 4 (for example a slot is made at the top of the latter, to insert therein said end of the spring) and, by its other end, to a part that remains stationary when the core is driven in rotation, for example the cover or end part 10 (for example a slot is made in this cover or this end part, to insert therein this other end of the spring). Thus, the actuator 33 can drive the core in rotation from a 1^{st} position towards a 2^{nd} position, the stoppage of the actuation of the actuator automatically causing a return of the core towards its 1^{st} position, or initial position. For example, the device can be in a rest position in which the fluid flows towards the outlet 12, the actuator driving the core 4 towards a position in which the fluid flows towards the outlet 20, the stoppage of the actuation of the actuator automatically causing a return of the core towards its initial position, that is to say towards the position in which the fluid flows towards the outlet 12.

This aspect of the invention is illustrated in FIG. 8, in which a torsion spring 60, one end 61 of which is connected to the upper part 30 of the core 4 and the other end 63 of which is connected to a lower part of the inlet cover 10, is visible.

The coupling means 36, and their housing in a lower compartment of the core 4, and/or the return means that have been described above in relation to FIGS. 6-8 can be applied not only to the distributor described above in relation to FIGS. 1-3 but also to any other distributor implementing a rotary element in a distribution body, in particular to any distributor:
including an injection of the fluid, not in an axial manner (according to the axis XX′) as described above, but in a manner lateral to the body 2; in this case, the case and the core each have a fluid inlet in the lateral wall 8 and in the lateral surface 32;
and/or for which the core includes a distribution channel having a uniform cross-section and the end 34 of which located facing the outlet orifice(s) can have an elongated shape as described above or have a circular shape which corresponds to the cross-sections of the openings 12, 20.

Preferably, the case 2 and the core 4 are made of plastic material reducing the mass of the distributor, which is particularly favourable in the motor vehicle field. Moreover, the plastic material is advantageously loaded with a material reducing friction. For example, the case and/or the core are made of polyphthalamide, for example of the PA6T/6I-GF30 type, very advantageously loaded with PTFE.

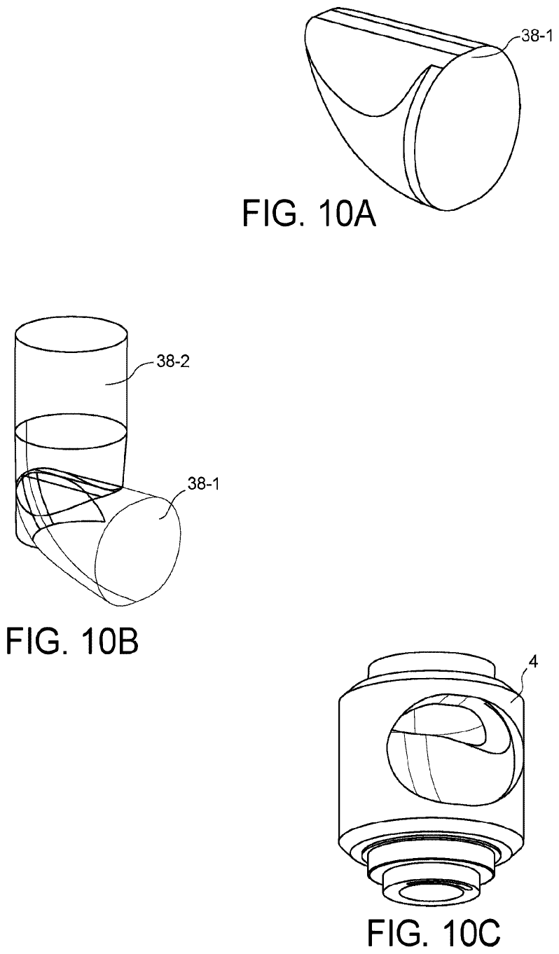

Moreover, they are preferably made by injection moulding which simplifies their manufacturing. With regard to the core, it is possible to create a shape of the inner duct 38, for example in 2 parts 38-1 and 38-2 as illustrated in FIGS. 10A and 10B, then to mould the core by injection around this shape; in these figures, the shape in 2 parts 38-1 and 38-2 also has a cross-section that increases, but less progressively than in the case of FIG. 3.

Nevertheless, the case and the core can be made of metal material, for example of stainless steel or of aluminium. The constraints on the surface states of the inner surface of the case and of the surface of the core are substantially reduced since they do not ensure the sealing.

FIG. 9 shows an embodiment of the assembly of the distributor of FIG. 1, after assembly. The references are those already described above in relation to FIG. 1. The coolant enters this device by the opening 11, according to the direction of the axis about which the rotation of the core is carried out by the actuator 33. The actuator is for example a gear motor MR, the output shaft of which is coupled to the core 4, for example as already described above. The gear motor is for example that described in the application WO2019/129984.

The operation of a distributor incorporating an actuation mechanism according to the invention will now be described.

The supply inlet 11 is connected to a source of pressurised liquid, for example a pump connected to a tank of liquid, and the two outlet orifices 12, 20 are connected for example to a heat or electric engine to be cooled.

When it is desired to supply the outlet orifice 20 with a maximum flow rate, the core 4 is rotated by the actuator 33 about the axis X so as to position the outlet 34 of the core facing the outlet orifice 20. The pressurised liquid circulates from the supply orifice 18 towards the outlet orifice 20 through the duct 38 as shown in FIG. 5A.

When it is desired to supply the outlet orifice 12 with a maximum flow rate, the core 4 is rotated by the actuator 33 about the axis XX′, so as to align the outlet 34 with the outlet orifice 20, the duct 38 thus connecting the supply orifice 11 and the outlet orifice 20, as shown in FIG. 5A.

As already explained above, the core 4 can occupy any intermediate angular position to ensure a proportional supply of the outlet orifices 12 and 20.

Other relative angular orientations of the outlets 12 and 20 are possible.

The invention allows to provide a distributor with reliable operation while substantially eliminating the constraints on the dimensions, the surface states, the required materials and the manufacturing methods.

The example described includes a supply orifice and two outlet orifices, but as mentioned above the present invention also applies to distributors including one inlet orifice and one outlet orifice, or one supply orifice and more than two outlet orifices, and to distributors including two supply orifices; a distributor according to the invention can include two axial fluid inlets, and the actuator can be moved to allow the passage of fluid in the second end or more and one or more outlet orifices. The configurations with several supply orifices and several outlet orifices can implement cores with several cavities or recesses 43 to allows several flows simultaneously or not in the distributor.

In the examples that were described above, the fluid enters by the orifice 11, flows via the duct 38 and exits the device by one or 2 of the lateral ducts 12, 20 (see for example the arrows of FIG. 9A which indicate the direction of flow of fluid).

It is possible to use the same device according to a reverse operation: it is the lateral ducts 12, 20 that are used as supply ducts and that are supplied with fluids, these fluids mix in the inner duct 38 and the mixture flows via the orifice 11, which becomes the outlet orifice. According to the angular position (about the axis XX′) of the core in the case, the proportion of the fluids that supply the device is modified. It is thus possible to introduce, according to the number of lateral ducts 12, 20, 2 or more than 2 fluids to be mixed. This use is illustrated in FIG. 9B, in which the arrows indicate the direction of flow of the fluids.

For example, the 2 fluids at the inlet can be different. Alternatively, they are of the same nature or are the same, but at different temperatures, wherein one can for example come from a heating member or element, for example a fuel cell, and the other from a cooling member or element, for example a radiator.

The distributor according to the invention, in particular associated with a gear motor, is particularly adapted to uses in the motor vehicle field (heat engine or electric engine) because of its reduced mass.

An actuation mechanism according to the present invention can be applied to a distributor provided in a vehicle with a heat, hybrid or electric engine, implementing for example a system(s) for regulating temperature and/or a system(s) for orienting a flow of air.

1. A hydraulic rotary distributor including a case and a core, said case including a lateral wall, two end walls defining a hydraulic chamber, in which the core capable of rotating in said chamber about an axis of rotation is housed, at least one axial orifice, and at least one lateral orifice, which open(s) into the hydraulic chamber, the core including a lateral surface facing the lateral wall of the case, an axial opening, at least one lateral orifice and a duct or a chamber that connects said axial opening and said lateral orifice and which allows a circulation of fluid, from or towards each of said lateral orifices according to the angular position of the core in the case, the core including coupling means to couple the end of a shaft of an actuator to the core, these coupling means including a part provided with a groove for receiving the end of a shaft of an actuator, the core including a housing capable of receiving said part, so that the latter transmits a rotation from the shaft to the core.

2. The hydraulic rotary distributor according to claim 1, said part, as well as the housing, having a cylindrical shape, and being provided with a lug having a parallelepipedic shape, the housing including a space for receiving said lug.

3. The hydraulic rotary distributor according to claim 2, said groove and said lug extending according to perpendicular or substantially perpendicular directions.

4. The hydraulic rotary distributor according to claim 1, said part as well as the housing having a parallelepipedic shape.

5. A hydraulic rotary distributor including a case and a core, said case comprising a lateral wall, two end walls defining a hydraulic chamber, in which the core capable of rotating in said chamber about an axis of rotation is housed, at least one axial orifice, and at least one lateral orifice, which open(s) into the hydraulic chamber, the core including a lateral surface facing the lateral wall of the case, an axial opening, at least one lateral orifice and a duct or a chamber that connects said axial opening and said lateral orifice and that allows a circulation of fluid, from or towards each of said lateral orifices according to the angular position of the core in the case, the distributor further including return means to bring the core back to an equilibrium or initial position after having been brought in rotation into a position distant from this equilibrium or initial position, said return means including a torsion spring, one end of which is fastened to the core and another end of which is fastened to a part of the distributor that remains stationary when the core is driven in rotation.

6. The hydraulic rotary distributor according to claim 1, the sealing between the lateral surface of the core and the lateral wall of the case (2) being ensured by the clearance between this lateral surface and this lateral wall.

7. (canceled)

8. (canceled)

9. The hydraulic rotary distributor according to claim 1, the core including a slot in the shape of an arc of a circle into which a stop penetrates for limiting its rotation when it is driven in rotation by an actuator.

10. The hydraulic rotary distributor according to claim 1, one of the end walls including an axial orifice that extends substantially perpendicularly to said axis of rotation, the lateral wall of the case including at least 2 lateral orifices, which open into the hydraulic chamber, the core including a lateral surface facing the lateral wall of the case, an axial face facing the axial orifice.

11. The hydraulic rotary distributor according to claim 1, the case including at least 2 lateral orifices, said lateral outlet of the core having a shape allowing, in at least one other intermediate angular position between said 1^{st} angular position and said 2^{nd} angular position, a partial flow from or towards the 2 lateral orifices simultaneously.

12. The hydraulic rotary distributor according to claim 11, wherein said lateral orifice of the core has an oblong or oval or ellipsoid shape, elongated according to an axis substantially perpendicular to the axis of rotation.

13. The hydraulic rotary distributor according to claim 1, wherein the distance that separates the 2 points farthest from said lateral orifice of the core is greater than the distance that separates the 2 lateral orifices of the case.

14. The hydraulic rotary distributor according to claim 13, wherein said inner duct of the core connects the axial face of the core and said lateral orifice of the core, this duct having a cross-section, perpendicularly to a direction of circulation of fluid, that increases from the axial face towards said lateral orifice.

15. The hydraulic rotary distributor according to claim 14, wherein the cross-section of the inner duct increases by a value between 1% and 3% for any increase, between 5° and 15°, in an angle measured between the axial face of the core and a plane perpendicular to the direction of flow of fluid.

16. (canceled)

17. The hydraulic rotary distributor according to claim 1, wherein the case includes at least 2 lateral orifices, which are extended by ducts that extend according to the axes, which have a point of intersection located to the rear of the centre of the core with respect to the lateral orifices of the case.

18. The hydraulic rotary solenoid distributor including a distributor according to claim 1 and an actuator driving the core in rotation.

19. The hydraulic rotary solenoid distributor according claim 18, the actuator including an output shaft aligned according to the axis of rotation.

20. A method for distributing a fluid using the hydraulic rotary solenoid distributor according to claim 18, the fluid being introduced by the axial orifice, for example according to the direction of the axis of rotation or perpendicularly to the latter, and being guided by the inner duct of the core towards the lateral orifice of the latter then, according to the orientation of the core in the case, towards one and/or the other of the 2 lateral orifices of the case.

21. The method according to claim 20, the fluid being a mixture of water and of glycol or being a coolant of a fuel cell.

22. (canceled)

23. A method for distributing a fluid using the hydraulic rotary solenoid distributor according to claim 18 or 19, fluids being introduced by the 2 lateral orifices of the case, these fluids being guided by the inner duct of the core towards the axial orifice and being at least partly mixed in this inner duct.

24. The method according to claim 23, the 2 fluids being of the same nature or being the same, but at different temperatures or one of the fluids coming from a heating member or element, for example a fuel cell, and the other coming from a cooling member or element, for example a radiator.

25. (canceled)
